(19) United States
(12) Patent Application Publication
(10) Pub. No.: US 2004/0112763 A1
(43) Pub. Date: Jun. 17, 2004

(54) Method for surface treatment of processed copper workpiece

(76) Inventors: Jin-Ichi Itoh, Tokyo (JP); Yasuaki Nishio, Shiga (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/380,477

(22) PCT Filed: Jul. 12, 2002
(86) PCT No.: PCT/JP02/07120

(30) Foreign Application Priority Data
Jul. 13, 2001 (JP) 2001-213434

(51) Int. Cl. C02F 1/461

(52) U.S. Cl. 205/746; 134/2

(57) ABSTRACT

The present invention provides a soft etching technique for degreasing and removal of oxide layers on the surface of a processed copper article and for improvement of adhesion with a resist film, and a technique by which the waste water treatment accompanying the soft etching can be made non-polluting. Namely, the surface of the processed copper article is treated with at first an electrolyzed alkaline water, then an electrolyzed acidic water and further an electrolyzed alkaline water, sequentially, and then subjected to washing with water and a drying treatment, and the waste water by the treatment with the electrolyzed acidic water and the waste water by the treatment with the electrolyzed alkaline water are mixed and neutralized, and from the thus obtained neutralized water, copper ions are recovered.

### TECHNICAL FIELD

The present invention relates to a method for treating the surface of a processed copper article such as a patterned copper electrode in a printed-wiring board, by using an electrolyzed acidic water. Particularly, it relates to a method suitable for a surface treatment for improving the adhesion to the copper surface of a resist film in a photosensitive resist coating in a step for forming electrically conductive copper pattern electrodes on a circuit board of e.g. a printed wiring; a surface treatment for removing oxides on a copper surface which is carried out as a pre-treatment of various inspection apparatuses or a pre-treatment of soldering; a surface treatment for removing surface residues after copper plating; or a surface treatment for removing alkali corrosion by alkaline chemicals. Further, the present invention also provides a method for reusing waste water generated in these steps.

### BACKGROUND ART

As a typical step for forming electrically conductive copper pattern electrodes on a circuit board as an electronic part, formation of a copper film on a board surface by e.g. vapor deposition or plating, formation of a photosensitive resist film, exposure with a mask interposed, development of a resist, etching of a copper foil portion after removal of a resist, and peeling of a resist, may be mentioned.

In the formation of the resist film on the copper foil, extremely high adhesion is demanded so as to realize precise wiring in subsequent etching steps.

As a general method for forming a resist film with high adhesion, studies from the aspect of a resist and studies from the aspect of a surface treatment of a copper surface may be mentioned.

From the aspect of a resist, as a resist process, a liquid resist process, an ED resist process, a dry film resist process, etc. may be mentioned. Among them, the liquid resist process and ED resist process have drawbacks that although the adhesion with copper is high, only one side coating can be made, resulting in low efficiency, and the thickness of the resist is at a level of 5 μm, resulting in low efficiencies of handling and protection of through holes. On the other hand, in the dry film resist process, a photosensitive dry film resist is bonded with a heating roll, by which the productivity is high and various demands can be satisfied, whereby the main stream is this process.

Accordingly, from the aspect of a surface treatment of a copper surface, in order to improve the adhesion with a laminate of this dry film resist, it is necessary to remove stains or oxide layers on a copper surface and to roughen the copper surface, and for this purpose, physical polishing of the copper surface or chemical polishing (soft etching) of the copper surface with chemical agents have been performed. Among these surface treatments, in recent years, since it is unavoidable in the physical polishing to cause a problem of copper stretching, the chemical polishing have often been used, and in this instance, it is considered necessary to remove stains and oxide layers on the copper surface accompanying the soft etching and to form a satin finished roughened surface, and such ideas are practiced. And, for this purpose, a method for chemical treatment with a sulfonic acid type or hydrochloric acid type chemical, etc. has been used. Likewise, the removal of oxides on the copper surface is treated with a sulfonic acid type or hydrochloric acid type chemical agent.

However, in recent years, the integration of LSI has been rapidly increased, high speed processing has been promoted, the distance between parts of electric wirings on a wiring board has been narrowed, and the number of leads drawn from the board has been remarkably increased. As a result, even if such products have passed the outgoing inspection test of board manufacturers, the possibility have been increased that breaking of wires is caused in the load test at the delivered side and claims are arisen. Further, after the removal of oxides by the treatment before inspection, etc., minute oxide layers are formed by remaining chemicals, and the outgoing inspection machine is not enough to detect the defects and such defects are found by the load test at the delivered side, by which claims are arisen.

Moreover, with respect to the chemicals conventionally used for the surface treatment, in the waste water discharged in a series of steps, since copper is fused into a sludge, the copper is not readily separated, and if this waste water is discharged as it is, the emission standard of heavy metals will be violated. Accordingly, the waste water is salvaged by an industrial waste management contractor, or by utilizing adsorbent additives, put in an coagulation tank, a sedimentation tank or a concentration tank, and compressed by a dehydrator, and disposed with payment of expensive costs. However, such measures can not drastically reduce the environmental load.

### DISCLOSURE OF THE INVENTION

The present inventors have conducted various studies on the above problems, and as a result, found that in the subsequent steps in which a copper film other than the required wiring (electrode pattern) is etched with iron liquor, the etching liquor tends to penetrate into a so-called void generated after the lamination of a resist, which is a minute spacing between a satin-finished copper film and a laminated dry resist, and overly erode the copper film, whereby the specified wire width can not be obtained and the breaking of wires is caused.

And, they have also found that this is attributable to the fact that the adhesion are not necessarily increased by the surface roughening by etching the copper surface into the satin-finished surface with the above-mentioned chemical agents which have been practiced for the preparation of a highly integrated, fine pattern wiring. Further, they have confirmed that as abuses by the chemical etching, the used chemicals remain, and by the remaining chemicals and oxidation caused by them, malfunction and misjudgment of the inspection machines are caused.

Accordingly, it has been demanded to develop a technique of soft etching in which the oxides can effectively be removed without using the above chemical agents, by which the adhesion of the resist film to the copper surface can be improved. Further, it has also been demanded to develop a technique by which the waste water treatment accompanying such soft etching can be made non-polluting.

It is an object of the present invention to solve the above-mentioned problems, and specifically, provide a method for surface treatment of a processed copper article wherein the degreasing of the surface of the processed copper article and the removal of an oxide layer or corrosion by alkaline chemicals can effectively be made, by which the adhesion with the resist film can be increased, and further the waste water generated by the surface treatment can be made non-polluting and safely treated.

Namely, the 1st aspect of the present invention is a method for surface treatment of a processed copper article which comprises treating a surface of a processed copper article by using, an electrolyzed acidic water (hereinafter referred to as Step 2).

As mentioned above, the base of the present invention is to carry out the surface treatment of a processed copper article by using an electrolyzed acidic water, and one of a series of results of researches and studies by the present inventors on an electrolyzed acidic water and an electrolyzed alkaline water obtainable by electrolyzing water.

According to the 1st aspect of the present invention, unlike the conventional treatment with chemicals, it is possible to form a soft etching having slightly soft unevenness on the surface of a processed copper article by removing the oxide layer of the copper surface and dissolving a slight amount of copper, and to fundamentally increase the adhesion of the resist film.

Further, since copper is hardly dissolved and only rust (oxide) on the copper surface can selectively be removed, this method causes no defects of fine electrode patterns on a circuit board.

Further, this treating liquor is basically water, and even if it remains in through holes, its pH rapidly increases upon reaction with a small amount of washing water, and it becomes water. Since the treating liquor thus has no residual tendency, it can easily be removed at a water washing portion in the subsequent step. Further, unlike the chemicals, the amount of washing water used can be reduced, and besides, the waste water after the treatment can easily be reused.

The 2nd aspect of the present invention is a method wherein after the treatment with the electrolyzed acidic water, a treatment with an electrolyzed alkaline water is carried out (hereinafter referred to as Step 3). Namely, the second aspect of the present invention is a method carried out by combining Step 2 and Step 3.

According to the 2nd aspect of the present invention, it is possible to prevent oxidation of the surface of the processed copper article after acid treatment and to expand the storage time after the washing with an acid.

The 3rd aspect of the present invention is a method wherein after the treatment with an electrolyzed acidic water, a washing treatment with water is carried out (hereinafter referred to as Step 4). Namely, the 3rd aspect of the present invention is a method carried out by combining Step 2 and Step 4.

According to the 3rd aspect of the present invention, it is possible to prevent oxidation of the surface of the processed copper article after acid treatment like the second aspect, whereby adhesion of a resist film can be increased.

The 4th aspect of the present invention is a method wherein after the treatment with an electrolyzed acidic water, the treatment with the electrolyzed acidic water is carried out, and further a washing treatment with water is carried out. Namely, the 4th aspect of the present invention is a method carried out by combining Step 2, Step 3 and Step 4.

According to the 4th aspect of the present invention, wherein after the treatment with an electrolyzed acidic water, a treatment is carried out by using an electrolyzed alkaline water for neutralization, and further a washing treatment with water is carried out, by which it is possible to effectively prevent oxidation of the surface of the processed copper article after acid treatment in Step 2, and adhesion of a resist film can be increased.

The 5th aspect of the present invention is a method wherein after the treatment with an electrolyzed acidic water (Step 2), the treatment with the electrolyzed alkaline water (Step 3) or the washing treatment with water (Step 4) is carried out immediately after the treatment with the electrolyzed acidic water. According to the 5th aspect of the present invention, it is possible to more adequately prevent oxidation of the surface of the processed copper article which has been subjected to the 2nd, 3rd or 4th aspect of the present invention, whereby adhesion of a resist film can be increased.

Here, “immediately after” means that when the treatment with an electrolyzed acidic water is carried out, since the oxidation power of the ionized acidic water on the copper surface is strong and the surface oxidation proceeds at a high rate, its post-treatment should be made as soon as possible, and specifically it should be started within 10 seconds, preferably within 5 seconds, after completion of Step 2.

The 6th aspect of the present invention is a method wherein before the treatment with an electrolyzed acidic water, a treatment with an electrolyzed alkaline water (hereinafter referred to as Step 1) is carried out as a pre-treatment. Namely, the 6th aspect of the present invention is a method wherein the surface treatment of a processed copper article is carried out by combining at least Step 1 and Step 2. According to the 6th aspect of the present invention, it is possible to remove by washing, stains or oil and fat adhered to the surface of the processed copper article by the electrolyzed alkaline water, and besides, oxide layers can be removed by the electrolyzed acidic water in the next step, whereby only the oxide layers on the copper surface can selectively be removed, and minute unevenness can be formed on the copper surface by etching with a slight amount of agents, and resultingly the adhesion of the resist film can be increased.

In a production line wherein a fine and precise circuit is formed by etching a copper film, it sometimes happen that oil components such as machine oil floating in air adhere to a board or substrate waiting for the next step, and adversely affect the subsequent steps. The above Step 1 should preferably be employed in the present invention so as to preliminarily remove the stains and produce precise boards.

The 7th aspect of the present invention is a method wherein after the treatments of the above Steps, a drying treatment is carried out (hereinafter referred to as Step 5). The Step 5 of the drying treatment should preferably be carried out after Step 3 or Step 4. According to the 7th aspect of the present invention, the copper surface neutralized with ionized alkaline water or ordinary water can be kept clean, the adhesion of the resist film can further be increased, and it is possible to completely remove the causes of breaking of wires due to excessive etching of copper with iron liquor after the formation of a resist film.

Since the treatment with an electrolyzed alkaline water in Step 3 shows an oxidation-preventing effect, it may be advantageous to omit Step 4 after Step 3 and to conduct Step 5, depending upon the processed copper article.

Here, in the drying treatment, it is preferred to evaporate at once the water content on the copper surface by utilizing dry air or an air knife.

The 8th aspect of the present invention is a method for surface treatment of a processed copper article according to any one of the first to seventh aspects of the present invention, wherein the electrolyzed acidic water is an electrolyzed acidic water having pH of at most 3, a residual chlorine concentration of at most 20 PPM and an oxidation-reduction potential of 1,000 to 1,300 mV, obtainable by electrolyzing water having incorporated as an electrolyte, a compound capable of liberating chlorine ions when dissolved in water, using an electrolysis tank having an ion permeable diaphragm between an anode and a cathode. According to the 8th aspect of the present invention, it is possible to remove the oxide on the copper surface and form minute unevenness on the copper surface, whereby the adhesion of the resist film can rapidly be increased.

Here, as the compound capable of liberating chlorine ions when dissolved in water, sodium chloride and potassium chloride which are water-soluble and of which their aqueous solutions are neutral, are preferably used.

Here, even if the chemical and physical properties of the electrolyzed acidic water are outside the above numerical values, the object of the present invention can be accomplished to some extent, but soft etching efficiency, etc. may sometimes be worsened.

Further, when the compound capable of liberating chlorine ions when dissolved in water, such as NaCl (sodium chloride) or KCl, is used as the electrolyte, if the residual chlorine concentration in a strongly acidic electrolyzed water exceeds 20 PPM, evolution of chlorine gas becomes high, and the working environment may be polluted, and copper ions dissolved in the acidic water bond to chlorine ions to form copper chloride, whereby the acidic water becomes turbid, and if it is continued to use the acidic water as it is, the copper bonds to carbon dioxide gas in air and form basic carbonate (so-called verdigris), whereby the copper surface is inadvertently oxidized. Accordingly, it is preferred to add the electrolyte in a slight amount e.g. at most 0.1% (wt%), and conduct the electrolysis at a high voltage of at least 50V.

The 9th aspect of the present invention is a method for surface treatment of a processed copper article, wherein the electrolyzed acidic water is an electrolyzed acidic water having pH of at most 3 and an oxidation-reduction potential of 1,000 to 1,300 mV, obtainable by electrolyzing water having incorporated as an electrolyte, a compound capable of liberating sulfate ions when dissolved in water, using an electrolysis tank having an ion permeable diaphragm between an anode and a cathode. When the compound capable of liberating sulfate ions is used as the electrolyte, since no chlorine ions remain at the acidic water side, no copper chloride as explained in the eight aspect of the present invention is formed.

Here, as the compound capable of liberating sulfate ions, ones of which the aqueous solutions are neutral, such as sodium sulfate, potassium sulfate and ammonium sulfate are preferred.

The 10th aspect of the present invention is a method for surface treatment of a processed copper article, wherein the electrolyzed alkaline water to be used for the treatment with the electrolyzed alkaline water (Step 3) subsequent to the treatment with the electrolyzed acidic water is an electrolyzed alkaline water having pH of at least 10 and an oxidation-reduction potential of −150 to −900 mV, obtainable by electrolyzing water by using an electrolysis tank having an ion permeable diaphragm between an anode and a cathode. According to the 10th aspect of the present invention, it is possible to effectively prevent the oxidation of the copper surface and also increase the adhesion of the resist film.

Here, even if the chemical and physical properties of the electrolyzed alkaline water fall outside the above numerical values, the object of the present invention can be accomplished to some extent, but rust-preventing effect by oxidation activity may sometimes become poor. Further, the surface tension is preferably at most 670 dyne/cm.

In order to rapidly neutralize the remaining electrolyzed acidic water, it is preferred to conduct showering with the electrolyzed alkaline water. Besides, a method wherein the electrolyzed alkaline water is impregnated into squeeze rollers, etc. and coated on the copper surface, and a method wherein the copper surface is immersed in an electrolyzed alkaline water for neutralization, are preferred from the viewpoint that it is thereby possible to prevent a phenomenon wherein pH is lowered by the reaction of the electrolyzed alkaline water with carbon dioxide gas in air.

The 11th aspect of the present invention is a method for surface treatment of a processed copper article, wherein the electrolyzed alkaline water to be used for the first treatment (Step 1) is an electrolyzed alkaline water heated to at least 40° C., having pH of at least 10, an oxidation-reduction potential of −150 to −900 mV and a surface tension of at most 670 dyne/cm, which is obtainable by electrolyzing water by using an electrolysis tank having an ion permeable diaphragm between an anode and a cathode. According to the 11th aspect of the present invention, ion residues of cations and anions can be removed and the surface can be perfectly cleaned, whereby it is possible to remove the oxide layer with an electrolyzed strongly acidic water in the next step, effectively and perfectly form a soft etching having a slightly soft unevenness on the surface of the processed copper article, and sufficiently increase the adhesion of the resist film.

Here, even if the chemical and physical properties of the electrolyzed alkaline water are outside the above numerical values, the object of the present invention can be accomplished to some extent, but the effect for cleaning the surface may sometimes become poor. Further, if the temperature of the electrolyzed alkaline water is lower than 40° C., since softening of oil and fat is insufficient, emulsification (dispersibility) of oil and fat is worsened, and it takes long time to conduct washing, such being undesirable.

Further, in the case of a product which is incompatible with sodium ions as the electrolyte, it is effective to use chemicals, for example, potassium ions such as potassium carbonate as an alkaline salt or potassium chloride as a neutral salt, or ammonium sulfate.

The 12th aspect of the present invention is a method for surface treatment of a processed copper article, wherein a waste water after the treatment with the electrolyzed acidic water is neutralized, and recovered or reused as a neutral water (hereinafter referred to as Step 6). According to the 12th aspect of the present invention, it is possible to reuse the waste water as general industrial water.

The 13th aspect of the present invention is a method for surface treatment of a processed copper article, wherein a waste water after the treatment with the electrolyzed acidic water and a waste water after the treatment with the electrolyzed alkaline water are mixed and treated, and recovered or reused as a neutral water (Step 6). According to the 13th aspect of the present invention, it is possible to reduce the treatment costs of the waste water, prevent environmental pollution, and reuse the waste water as general industrial water. Here, in the waste water treatment in the case of the conventional etching treatment with chemicals, it has been required to conduct non-polluting treatment by a large-scale treating tank with expensive costs.

The 14th aspect of the present invention is a method for surface treatment of a processed copper article, wherein copper ions are separated and recovered from a waste water after the treatment with the electrolyzed acidic water or a neutral water obtainable by neutralizing said waste water (hereinafter referred to as Step 7). According to the 14th aspect of the present invention, copper ions contained in the waste water can easily be separated and recovered.

The 15th aspect of the present invention is a method for surface treatment of a processed copper article, wherein a waste water after the treatment with the electrolyzed acidic water or a neutral water obtainable by neutralizing said waste water is led into a copper ion recovery tank to separate and recover copper ions as copper hydroxide (Step 7). According to the 15th aspect of the present invention, copper ions contained in the waste water can easily be separated and recovered.

The 16th aspect of the present invention is a method for surface treatment of a processed copper article, wherein the processed copper article is one formed as a surface conductive electrode on a circuit board as an electronic part. According to the 16th aspect of the present invention, it is possible to produce an excellent printed wiring circuit board having a fine conductive copper electrode pattern of high density, and a high integration degree such as VLSI.

### BRIEF EXPLANATION OF THE DRAWING

FIG. 1 is a view illustrating an apparatus for practicing Steps 1, 2, 6 and 7, in an embodiment of the method for surface treatment of a processed copper article of the present invention.

FIG. 2 is a view illustrating an apparatus for practicing Steps 3, 4 and 5 in the above embodiment.

FIG. 3 is a schematic view illustrating an example of an apparatus for producing the electrolyzed water to be used in the present invention.

FIG. 4 is a view illustrating an apparatus for practicing Steps 1, 2, 6 and 7, in another embodiment of the method for surface treatment of a processed copper article of the present invention.

### BEST MODE FOR CARRYING OUT THE INVENTION

In the present invention, the processed copper article is a product made of copper, a material comprising copper as a main component, or various materials subjected to surface treated.

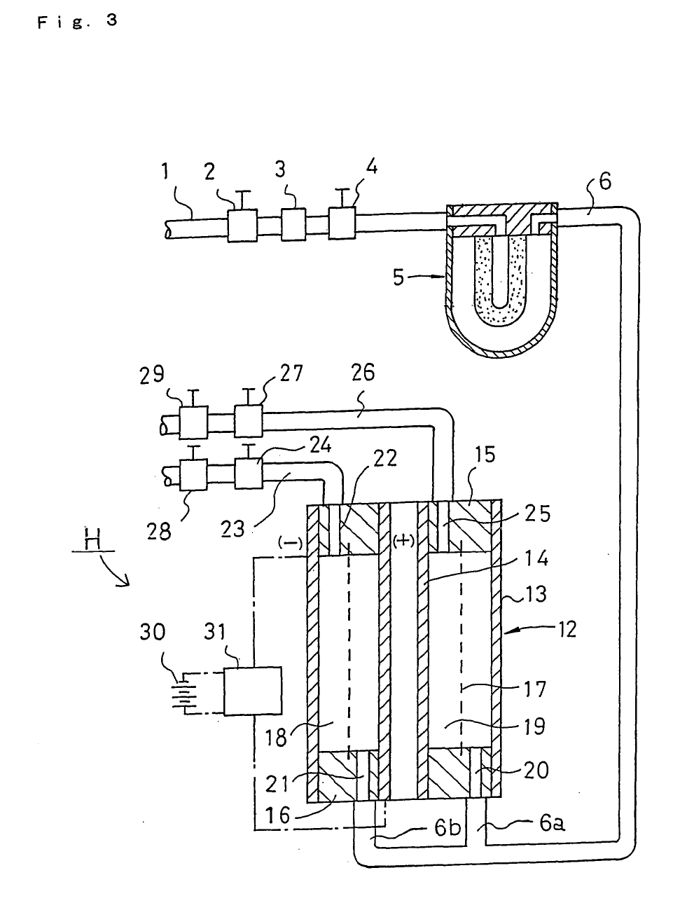

The electrolyzed acidic water and the electrolyzed alkaline water used in the present invention are an ionized strongly acidic water and an ionized strongly alkaline water, respectively, basically obtainable by electrolysis of water in an electrolysis tank. FIG. 3 shows an example of an apparatus for producing preferred ionized water used in the present invention.

In the present invention, the treatment by the electrolyzed alkaline water, electrolyzed acidic water or ordinary water, is generally preferably carried out by immersion or showering.

The present invention provides a method developed for the pre-treatment of resist film-coating, particularly in the steps for forming a conductive copper electrode on the surface of a circuit board as an electronic part. By this method, it is possible to prepare an excellent highly integrated printed wiring circuit board, such as VLDI having a high density and a fine conductive copper electrode pattern. The present invention may be applied to an acid treatment step of a printed wiring circuit board other than the above steps, for example, a pre-treatment of checker, a pre-treatment of optical inspection of circuit, treatments before and after solder resist, treatments before and after finishing, and pre- and post-treatments of plating. Since the present invention is effective for removal of corrosion by alkaline chemicals, it is effective for a treatment after development of a photosensitive resin, and a treatment after peeling. Further, the present invention may preferably be applicable to not only the printed wiring circuit board, but also all the processed copper articles, for example, acid washing treatment for the removal of oxide layers or surface stains or contaminants on the products obtainable by press working or etching of copper, such as board shielding, IC lead frames, flat antenna and flat coils for electric motors.

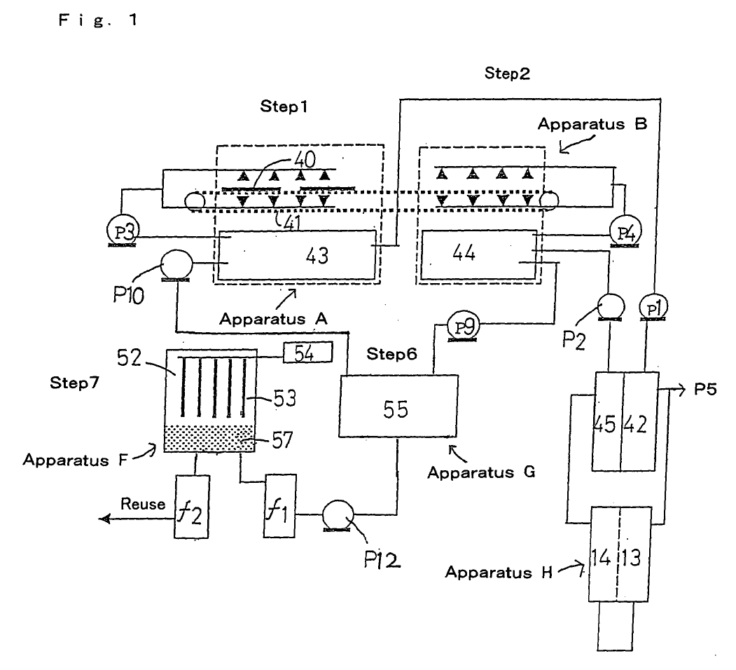

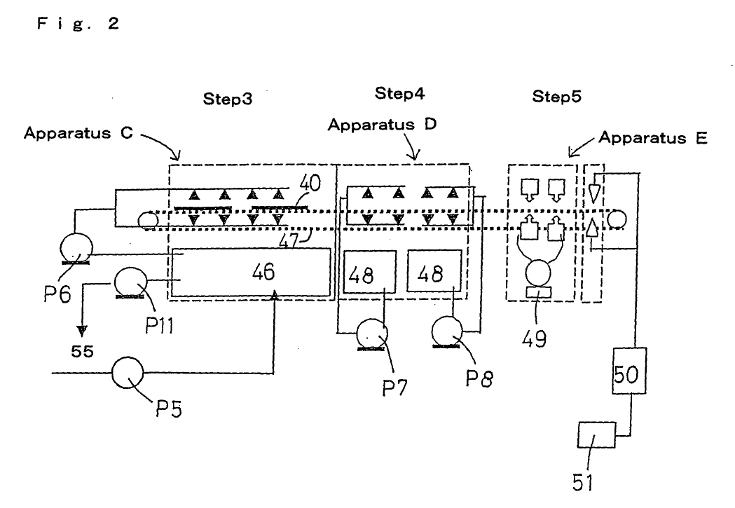

FIG. 1 and FIG. 2 show an example schematically illustrating the entire system for practicing the present invention. In FIG. 1 and FIG. 2, the flow of treating the processed copper article in this system continues from FIG. 1 to FIG. 2.

Namely, this preferred system is basically constituted by a treatment apparatus A with an electrolyzed alkaline water as Step 1; a treatment apparatus B with an electrolyzed acidic water as Step 2; a treatment apparatus C with an electrolyzed alkaline water as Step 3; a washing treatment apparatus D as Step 4; a drying treatment apparatus E as Step 5; a waste water-neutralizing and reusing apparatus G as Step 6; and a copper ion-separating and recovering apparatus F as Step 7; and further an apparatus H for producing preferred ionized water used in the present invention.

In this system, basically, the 1st aspect of the present invention can be practiced by using at least apparatuses B and H; the 2nd aspect, at least apparatuses B, C and H; the 3rd aspect, at least apparatuses B, D and H; the 4th aspect, at least apparatuses B, C, D and H; the 5th aspect, at least apparatuses B, C and H, at least apparatuses B, D and H, or at least apparatuses B, C , D and H; the 6th aspect, at least apparatuses A, B and H; the 7th aspect, at least apparatuses B, C, E and H or at least apparatuses B, C, D, E and H; the 8th aspect, the 9th aspect, the 10th aspect and the 11th aspect, at least apparatus H in addition to any one of the above aspects; the 12th aspect and the 13th aspect, at least apparatuses B, G and H; the 14th aspect and the 15th aspect, at least apparatuses B, G, F and H.

First, the apparatus H for producing preferred electrolyzed water used in the present invention as illustrated in FIG. 3 will be explained in detail. This apparatus H is mainly constituted by a raw water lead-in pipe 1, a connecting pipe 6, a filter tank 5 disposed in the middle thereof, an electrolysis tank 12, an electrolyzed alkaline water lead-out pipe 23 and an electrolyzed acidic water lead-out pipe 26. Here, the raw water lead-in pipe 1 is connected to the filter tank via a pressure reducing valve 2, a pressure switch 3 and an electromagnetic valve 4, and further connected to the electrolysis tank 12 via the connecting pipe 6.

The electrolysis tank 12 has a structure wherein a cathode 13 made of a cylindrical stainless steel electrode and an anode 14 made of a cylindrical titanium-platinum electrode having a diameter smaller than that of the cathode 13, are disposed concentrically, and the upper and lower end faces thereof are sealed with annular covers 15, 16. Further, between the cathode 13 and the anode 14, a diaphragm 17 likewise having a cylindrical shape is disposed, both ends thereof being supported by covers 15, 16, and the inside of the electrolysis tank 12 is partitioned into a cathode chamber 18 at the outside and an anode chamber 19 at the inside at the proportion of a volume ratio of from 3:7 to 5:5 (ideally, a proportion of 45:55). This diaphragm 17 allows cations to permeate from the anode chamber 19 side to the cathode chamber 18 side and anions to permeate from the cathode chamber 18 side to the anode chamber 19 side. The front end of the connecting pipe 6 is branched into 6a, 6b, and a pipe 6a is connected to a lead-in passage 20 towards the cathode chamber 18 disposed in the cover 16 at the bottom portion of the electrolysis tank 12, and another pipe 6b is connected to a lead-in passage 21 towards the anode chamber 19 disposed in the cover 16. Both of 6a, 6b have the same diameter and a structure wherein a raw water is led therein at the same pressure.

Further, on the cover 15 at the upper portion of the electrolysis tank 12, a lead-out passage 22 for taking out the ionized alkaline water from the cathode chamber 18 is disposed, and an ionized alkaline water lead-out pipe 23 is connected thereto, through which the ionized alkaline water is supplied via an electromagnetic valve 24 and a flow rate control valve 28. Further, on the cover 15 at the upper portion of the electrolysis tank 12, a lead-out passage 25 for taking out the ionized acidic water from the anode chamber 19 is disposed, and an ionized acidic water lead-out passage 26 is connected thereto, through which the ionized acidic water is supplied via an electromagnetic valve 27 and a flow rate control valve 29.

By the above flow rate control valve 29, 28, the discharge amount from the anode chamber 19 and the discharge amount from the cathode chamber 18 are adjusted so that the ratio of these discharge amounts will be 4.5:5.5. Here, in the electrolysis tank 12, a power source 30 for supplying electric power to the anode 14 and the cathode 13, and a controller 31 for controlling the electric power from the power source 30 are disposed. Further, although not shown in the drawings, in the anode chamber 19, eight round bars made of a resin (PP, PTFE, etc.) as insulators having a diameter of 2 mm, are disposed at a spacing of 3 cm, in parallel along the axial direction of the anode 14.

Accordingly, when the raw water is led from the raw water lead-in pipe 1 to the filter tank 5 via the pressure-reducing valve 2, the pressure switch 3 and the electromagnetic valve 4, particulates having a size of at least 10 μm in the raw water are captured so that the diaphragm 17 will not be clogged, and the raw water pass the filter tank and flow out of the connecting pipe 6.

The raw water flowing out of the connecting pipe 6 is branched into the branch pipes 6a, 6b, and flow in the cathode chamber 18 and the anode chamber 19 of the electrolysis tank 12 at the same pressure and the same flow rate, respectively. The influent raw water into the anode chamber 19 flow within the anode chamber 19 in a proper direction by the resin round bars. In the electrolysis chamber 12, electric voltage is applied between the anode 14 and the cathode 13, by which electrolysis of the raw water is carried out. This voltage is preferably 25 to 75V when the spacing between the anode 14 and the cathode 13 is 10 mm. More preferably, the electric power is adjusted by the controller 31 so that the electric voltage will be 40 to 70V and the electric current will be 16 to 30 A, and the flow rate is adjusted so that ionized acidic water will be discharged from the anode chamber 19 at a flow rate of 1 to 2 liters/minute and the ionized alkaline water will be likewise discharged from the cathode chamber 18 at a flow rate of 1 to 2 liters/minute.

Here, when the concentration of ions dissolved in the raw water is too low, it is preferred to conduct the electrolysis by the above electrolysis apparatus after adding the electrolyte to the raw water. As such an electrolyte, a compound capable of liberating chlorine ions when dissolved in water, such as sodium chloride or potassium chloride, and a compound capable of liberating sulfate ions when dissolved in water, such as sodium sulfate, potassium sulfate or ammonium sulfate, may, for example, be preferably used.

The thus obtained electrolyzed acidic water preferably has pH of at most 3 and an oxidation-reduction potential of 1,000 to 1,300 mV. Further, when the compound capable of liberating chlorine ions when dissolved in water is used as the electrolyte, the residual chlorine concentration is preferably at most 20 PPM. Furthermore, as the electrolyzed alkaline water, it is preferred that pH is at least 10, the oxidation-reduction potential is −150 to −900 mV, and the surface tension is at most 670 dyne/cm.

Even if an electrolysis apparatus controlled at a level of an electric voltage of 5 to 40V and an electric current of 16 to 25 A by increasing the electrolyte concentration is used, it is possible to produce an ionized alkaline water having pH of at least 10 and an oxidation-reduction potential of −150 to −900 mV, and an ionized acidic water having pH of at most 3 and an oxidation-reduction potential of 1,000 to 1,300 mV, respectively. However, when the compound capable of liberating chlorine ions when dissolved in water is used as the electrolyte, it is preferred to adjust its added amount to water at most 0.1 wt% so as to adjust the residual chlorine concentration in the obtained electrolyzed acidic water at most 20 PPM. Further, according to the experiment wherein the amount of copper ions dissolved when washed with an ionized acidic water is measured, when using an ionized acidic water obtained by electrolyzing under the conditions of 60V and 25 A, the copper ion amount is 129.1 mg/l, and when using an ionized acidic water obtained by electrolyzing under the conditions of 12V and 25 A, the copper ion amount is 81.8 mg/l. As mentioned in the foregoing, when using an ionized acidic water obtained by electrolysis at a high electric voltage, copper ions are dissolved in a larger amount and the efficiency is higher than the lower electric voltage.

In the present invention, first, a board 40 (hereinafter simply referred to as board) to be surface treated, for example, a processed copper article which is plated with a copper film, is mounted on a ring or a roller conveyer 41, and in Step 1, subjected to washing treatment with an electrolyzed alkaline water in a treatment apparatus A.

The electrolyzed alkaline water is one produced by the apparatus H for producing an electrolyzed water as illustrated in detail in FIG. 3 and has the above properties. And, the ionized water discharged from the cathode side of the apparatus H for producing an electrolyzed water, is stored in an alkaline water tank 42, and supplied to a tank 43 at the lower side of the treatment apparatus A by a pump Pl, and then supplied to Step 1 by a pump P3. The washing method is preferably showering, immersion, etc., and may be application of ultrasonic wave. In the system of FIG. 1 and FIG. 2, the washing of the board surface is made by showering in the entire system including the post-treatment.

In the first step, if the board surface is very clean, the washing is not necessarily required. However, even if washing is made in such instance, since the washing is an alkaline water washing with the electrolyzed alkaline water, the article to be treated can be subjected to the next washing treatment with the electrolyzed acidic water without performing the water washing treatment which has been required to completely remove the alkali components remaining in conventional alkaline water washing treatment.

Then, the board 40 subjected to removal of stains or alkali degreasing in the treatment apparatus A, is transported to a treatment apparatus B as Step 2. In the treatment apparatus B, the board is subjected to a washing treatment with an electrolyzed acidic water. The electrolyzed acidic water is one produced by the apparatus H for producing an electrolyzed water as explained above and has the above properties. And, the ionized acidic water discharged from the anode side of the apparatus H for producing an electrolyzed water is stored in an acidic water tank 45, and supplied to a tank 44 at the lower side of the treatment apparatus B by a pump P2, and then supplied to Step 2 by a pump P4.

Then, the board subjected to soft etching of the copper surface with the electrolyzed acidic water as the basic of the present invention in the treatment apparatus B, is transported to a treatment apparatus C with the electrolyzed alkaline water as Step 3.

Here, it has been found that since the board subjected to soft etching of the copper surface with the electrolyzed acidic water in the treatment apparatus B has been treated with the electrolyzed strongly acidic water, the oxidation of the surface starts very rapidly. Accordingly, it is important to transport the board as soon as possible after the treatment with the electrolyzed acidic water. Specifically, immediately after completion of the treatment with the electrolyzed acidic water, draining with e.g. squeeze rollers is carried out, and after the draining, although depending upon the pH value of the electrolyzed acidic water used, preferably within 10 seconds, particularly preferably within 5 seconds, the board should be transported to the treatment apparatus C with the electrolyzed alkaline water as Step 3. Here, when the board is subjected to the water washing treatment in Step 4 without conducting the treatment with the electrolyzed alkaline water as Step 3, it is likewise preferred to subject the board to the water washing treatment within 10 seconds, particularly preferably within 5 seconds, after the draining of the electrolyzed acidic water. In this instance, the squeeze rollers for draining are not necessary, and the board may be immediately subjected to the water washing treatment.

The ionized alkaline water to be used in Step 3 is one produced by the apparatus H for producing an electrolyzed water as illustrated in detail in FIG. 3 and has the above properties. And, the ionized water discharged from the cathode side of the apparatus H for producing an electrolyzed water is stored in an alkaline water tank 42, and supplied to a tank 46 at the lower side of the treatment apparatus C by a pump P5, and then supplied to Step 3 for use by a pump P6.

Then, the board washed with the ionized alkaline water is transported by a ring or a roller conveyer 47, and washed with water in the treatment apparatus D for treatment with water as Step 4. The water washing is carried out by showering of water which is stored in a water tank 48 of the treatment apparatus D and supplied by pumps P7, P8.

The board treated with water is, preferably after draining with e.g. squeeze rollers, finally dried in the draying apparatus E as Step 5, and the series of treatments is finished. In the draying treatment, preferably, the water contents are scattered by high pressure air generated by a ring blower 49, and the board is subjected to air drying by dried air of compressed air of a compressor 51 dried by an air dryer 50. The air drying may, of course, be drying with air heated by an ordinary heater.

On the other hand, it is important to treat the electrolyzed water used in these steps and discharged as waste water. In the present invention, the treating liquor used in each step is an electrolyzed water, not chemicals, and therefore, the waste water is fundamentally water, and its treatment is extremely easy, and the step for this treatment will be explained below.

First, the waste water of the electrolyzed water as the main component, generated in the treatment apparatus B as a result of the treatment with the electrolyzed acidic water as the basic of the present invention, is once stored in a tank 44 provided at the lower portion of the treatment apparatus B. For the treatment of this waste water, it is necessary to separate and recover copper ions contained in this waste water.

In this instance, prior to the separation and recovery of the copper ions, it is preferred to neutralize the waste water. Namely, as Step 6, the above waste water is neutralized by the apparatus G as shown in FIG. 1. This apparatus G has a pH-adjusting tank 55 for neutralization of the waste water. The neutralization treatment can be carried out, in the pH-adjusting tank 55, preferably by supplying an alkaline water stored in the tank 43 at the lower side of the apparatus A, to the stored acidic waste water. by a pump 10. Namely, while measuring the pH value of the acidic waste water stored in the pH-adjusting tank 55, the electrolyzed alkaline water stored in the lower tank 43 is gradually supplied thereinto so as to adjust the pH value to about 7.

This method is a neutralization treatment method which is extremely simple and convenient and by which the environmental load can be reduced to a great extent, i.e. supplying the alkaline water stored in the tank 43 at the lower side of the apparatus A to the pH-adjusting tank 55 having the acidic waste water stored therein. Here, such a simple and convenient neutralization method may be carried out by supplying the alkaline water stored in the tank 46 at the lower side of the apparatus C by a pump 11.

On the other hand, an example of the copper ion-separating and recovering apparatus is shown as Step 7, i.e. an apparatus F in FIG. 1. This apparatus F has a copper ion-recovering tank 52 in which copper ions are settled as copper hydroxide. And, the neutralized water neutralized in the pH-adjusting tank 55 is transferred to the copper ion-recovering tank 52 via a filter f1 by a pump 12. In the copper ion-recovering tank 52, the neutralized water is brought into contact with substances having an ionity higher than the ionity of copper, for example, forming copper hydroxide on the surface of an iron material 53, whereby the copper ions in the neutralized water can be separated. Namely, when the iron material is put in the neutralized water, iron ions are substituted with copper ions and copper ions are deposited on the surface of the iron material, and since it is conducted in water, the copper ions are deposited as copper hydroxide on the surface of the iron material. Here, as the iron material, a rod-like shape and a plate-like shape may be used, but powdery form is preferred in which the surface area is large.

With respect to the copper hydroxide, for example, a vibrating apparatus 54 is attached to the iron material 53, and by the vibration by the vibrating apparatus 54 or by stirring, the copper hydroxide will be separated from the iron material. Accordingly, the separated copper hydroxide 58 may be settled on the bottom of the copper ion-recovering tank 52, and the waste water containing the settled copper hydroxide can be recovered via a filter f2.

Here, the recovery of copper ions may very easily be made by the recovery in the form of copper hydroxide, but other methods may, of course, be used. For example, copper ions may be recovered electrically by utilizing the principle of copper plating. In this instance, a stainless steel plate as an anode and a copper plate as a cathode are put in the neutralized water and direct current electrolysis is carried out, whereby copper is deposited as pure copper at the cathode side by the principle of copper plating, and recovered.

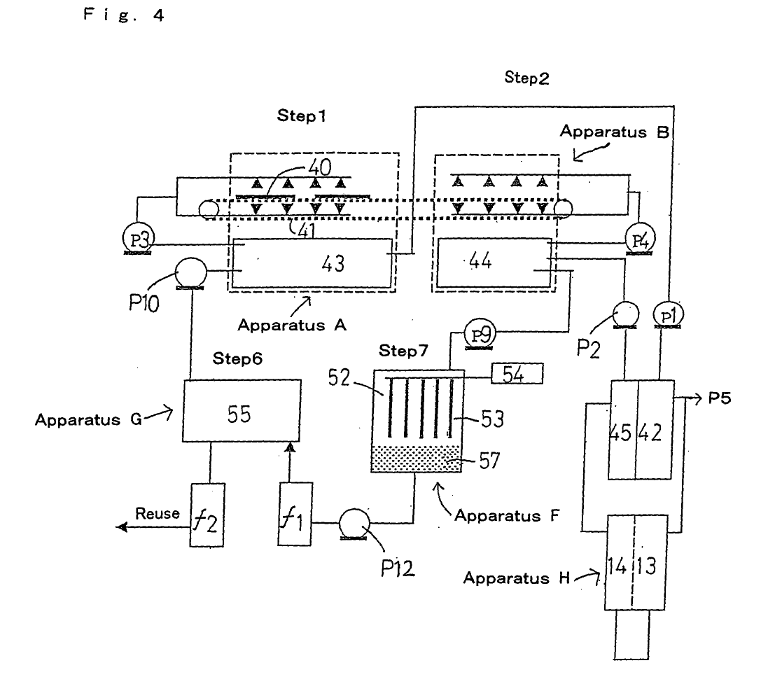

In FIG. 1, an example is shown wherein after Step 6 for neutralization treatment, Step 7 for separation and recovery of copper ions is carried out. However, as shown in FIG. 4, apparatuses G and F may be inversely disposed so that Step 6 for neutralization treatment is carried out after Step 7 for separation and recovery of copper ions.

The waste water which is neutralized and from which copper ions are recovered as mentioned above, may be passed through a filter f2 for removal of oils and residues, so as to make it non-polluting, whereby it is reduced to a general industrial water which meets the standard of water supply, and can be reused.

### EXAMPLES

Preparation of an Electrolyzed Acidic Water and an Electrolyzed Alkaline Water

As a raw water, city water was used, and an apparatus H as shown in FIG. 3 was used, and electrolysis was carried out under the conditions that the electric voltage was 60V, the electric current was 20 A, the flow rate of the ionized acidic water was 2 liters/minute, and the flow rate,of the ionized alkaline water was 2 liters/minute, whereby an electrolyzed acidic water and an electrolyzed alkaline water were produced. With respect to the thus obtained electrolyzed acidic water and electrolyzed alkaline water, and ordinary city water, the surface tension, oxidation-reduction potential (ORP), the residual chlorine concentration (PPM) and pH were measured, and the results are indicated in Table 1.

TABLE 1

| | | Oxidation- | Residual | |
|---|---|---|---|---|
| | Surface | reduction | chlorine | |
| | tension | potential | concentra- | |
| | (dyne/cm) | (mV) | tion (PPM) | pH |
| Electrolyti- | 62.4 | −855 | 0 | 11.43 |
| cally ionized | | | | |
| alkaline water | | | | |
| Electrolyti- | 63.4 | +1108 | 12 | 2.31 |
| cally ionized | | | | |
| acidic water | | | | |
| City water | 72.2 | +352 | 0.5 | 7.84 |

Here, the pH value and the oxidation-reduction potential were measured by “Casterny LAB pH/Ion meter F24”, tradename of Horiba Seisakusho Co. Further, the surface tension was measured with a du Noulli tensiometer manufactured by Taihei Rika Kogyo K. K. at 20° C.

From the results of Table 1, it is found that both the electrolyzed acidic water and the electrolyzed alkaline water are low in the surface tension as compared with the city water, and excellent in the wettability to the surface of the processed copper article to be washed, and thereby capable of exhibiting washing effect rapidly.

Preparation of a Processed Copper Article to be Washed

A printed wiring board (substrate material: glass fiber-reinforced epoxy resin) on which a copper film having a thickness of 18 mμ is formed, was used. It was observed by naked eyes that substantial amounts of oil and fat, and dust adhered thereto.

### Example 1

After simply washing the above board with water, the board was mounted on a conveyer 41 of a washing apparatus A as shown in FIG. 1, and while moving the conveyer 41 at a rate of 60 cm per minute, a washing treatment with the electrolyzed alkaline water was carried out. In the washing treatment, the ionized alkaline water indicated in Table 1 was heated to 50° C., and the washing treatment was carried out at a rate of 80 liters/minute for 1 minute by showering.

Then, while continuing the transportation of the board 40 on the conveyer 41, a washing treatment with the electrolyzed acidic water was carried out by using a washing apparatus B as shown in FIG. 1. The washing was carried out by using the electrolyzed acidic water as indicated in Table 1 at a rate of 120 liters/minute by showering.

Then, immediately after the board 40 left the end point of the washing apparatus B with the electrolyzed acidic water, the board 40 was passed between the squeeze rollers (not shown), and within 3 seconds after passing through the squeeze rollers, the board 40 was mounted on a washing apparatus C as shown in FIG. 2, and while moving the conveyer 47 at a rate of 60 cm per minute, a washing treatment with a electrolyzed alkaline water was carried out. The washing was carried out at a rate of 80 liters/minute for 30 seconds by showering.

Further, while transporting the board 40 on the conveyer 47, a washing treatment with water was carried out by a washing apparatus E as shown in FIG. 2. The washing was carried out by using pure water having passed through ion exchange resins, at a rate of 20 liters/minute for 20 seconds by showering.

Further, while transporting the board 40 on the conveyer 47, a draining and drying treatment was carried out by a drying apparatus E as shown in FIG. 2. The draining was carried out by using a two-stage ring blower 49, at both the upper and lower portions, and in the final drying, dry air was blown by an air dryer 50 to remove the water contents at once so as to completely dry the board.

With respect to the thus obtained board, the surface characteristics were observed and measured, and the results are as mentioned below.

Results of Observation

The oxide layer on the surface was completely removed, and the copper surface colored in brown before the treatment was turned into pink color which is the base material color of copper.

In the macrophotography of 3,000 magnifications by a microscope, on the copper surface which had a clean-cut configuration since the oxide layer was removed, no sharp edge was observed and the plated copper particles themselves randomly formed in granular form were observed.

Results of Measurement

From the data of a surface roughness tester, if the stain was corrected, the board showed no substantial difference from the board material immediately after delivery, and it was considered that no hard etching was made, but only the removal of the oxide layer on the surface and the etching of the sharp edges in a small amount were conducted.

The thus obtained board had very excellent surface characteristics, substantially at the same level as a copper foil surface of a board made of a molded glass fiber-reinforced epoxy resin on which the copper foil is adhered or a copper-plated surface provided on this copper foil surface of the board, which is produced by a copper-clad laminate manufacturer. Further, with respect to this board, in order to confirm the excellent adhesion to a photosensitive resist film, the following tests were carried out, and the results are indicated below.

Test Method of Adhesion

On a photosensitive resin (dry film; Hitachi Kasei, “Photech”) , grids of 5 mm×5 mm were formed over the area of 50 mm ×50 mm. After development and drying, peeling test was conducted ten times with a tape manufactured by 3M Co., and the average value of the number of peeling was measured.

Test Results of Adhesion

Treated with an electrolyzed acidic water: 0.1

### Comparative Example 1

Example 1 was repeated by conducting a chemical treatment with an acidic water by using a soft etching agent (CZ-8000S) as generally used in the prior art, instead of the treatment with the electrolyzed acidic water in the apparatus B, and a similar board was obtained. With respect to this board, the results of inspection, the measurement results and the test results of adhesion conducted in the same manner as in Example 1 are as follows:

Results of Inspection

The surface was satin finished, and high etching effect was observed.

Portions slightly dent in the entirety, although not dent by impact, and portions not so were observed.

Measurement Results

In the surface roughness data, fine waves as the characteristic feature of the satin finished surface were observed.

Test Results of Adhesion

Treated with a soft etching agent (CZ-8000S): 0.3

### Example 2

The waste water of the electrolyzed acidic water generated by the treatment step with the electrolyzed acidic water in the apparatus B in Example 1, was stored in the lower tank 44, and then, led into the pH-adjusting tank 55 by the pump 9. Further, the washing waste water of the electrolyzed alkaline water stored in the lower tank 43 in the apparatus A and the washing waste water of the electrolyzed alkaline water stored in the lower tank 46, were led into the pH-adjusting tank 55 by the pumps 10 and 11, respectively. And, in the pH-adjusting tank 55, the waste water of the electrolyzed acidic water and the waste water of the electrolyzed alkaline water were mixed and converted to neutral water.

The neutral water was led into the copper ion recovery tank 52 by a pump 12, and recovery of copper ions were conducted in the copper ion recovery tank 52. Namely, into the copper ion recovery tank 52, 10 liters of the neutral water of 21° C. was charged, and a PE mesh bag containing iron powder of 100% purity (iron powder in a disposable pocket warmer) was immersed in this neutral water and left for 10 hours. Copper ions were deposited as copper hydroxide on the iron powder surface. By applying vibration to the mesh bag containing the iron powder to peel off the copper hydroxide and settle it on the bottom of the recovery tank, the copper ions were recovered.

Then, after separation and removal of copper hydroxide by the filter f2, the waste water taken out. The thus obtained waste water was substantially neutral of pH 7.2 to 7.8, and other than iron contents, contained no heavy metals hazardous to human bodies and ones added to the raw water before electrolysis. And, nothing was detected other than copper ions not settled due to insufficient reaction with iron. Accordingly, the waste water could be sufficiently reused as industrial water, by separating and removing oils and residues remaining in little amounts by a filter. Here, in order to completely recover the copper ions, it is believed that recovery can securely be made by electroplating.

Industrial Applicability

According to the present invention, wherein a processed copper article is treated by washing with an electrolyzed acidic water, adhesion between a resist and a copper board can be improved to a great extent, by a soft etching technique basically using no chemical agent. As a result, in the steps for producing a circuit board by etching copper films other than required wirings (electrode pattern) by e.g. iron liquor, it is possible to solve at once the problem in the prior art wherein the etching liquor flows in minute spacing between the laminated resist and the satin finished copper film, so-called voids, generated after lamination of the resist, and erodes the copper film in a larger area than required, whereby specified wire width cannot be obtained and breaking of wires is caused.

The above effect is extremely important for the production of circuit boards for which high density and fine patterned wirings are demanded.

Further, it becomes possible to make the waste water treatment non-polluting, reuse the waste water and reduce the environmental load to a great extent, which have been difficult by the conventional washing treatment with chemical agents.

1. A method for surface treatment of a processed copper article, which comprises treating a surface of a processed copper article by using an electrolyzed acidic water.

2. The method for surface treatment of a processed copper article according to claim 1, wherein after the treatment with the electrolyzed acidic water, a treatment with an electrolyzed alkaline water is carried out.

3. The method for surface treatment of a processed copper article according to claim 1, wherein after the treatment with an electrolyzed acidic water, a washing treatment with water is carried out.

4. The method for surface treatment of a processed copper article according to claim 2, wherein after the treatment with the electrolyzed acidic water, the treatment with the electrolyzed alkaline water is carried out, and further a washing treatment with water is carried out,

5. The method for surface treatment of a processed copper article according to any one of claims 2 to 4, wherein after the treatment with the electrolyzed acidic water, the treatment with the electrolyzed alkaline water or the washing treatment with water is carried out immediately after the treatment with the electrolyzed acidic water.

6. The method for surface treatment of a processed copper article according to any one of claims 1 to 5, wherein before the treatment with the electrolyzed acidic water, a pre-treatment with an electrolyzed alkaline water is carried out.

7. The method for surface treatment of a processed copper article according to any one of claims 1 to 6, wherein further a drying treatment is carried out.

8. The method for surface treatment of a processed copper article according to any one of claims 1 to 7, wherein the electrolyzed acidic water is an electrolyzed acidic water having pH of at most 3, a residual chlorine concentration of at most 20 PPM and an oxidation-reduction potential of 1,000 to 1,300 mV, obtainable by electrolyzing water having incorporated as an electrolyte, a compound capable of liberating chlorine ions when dissolved in water, using an electrolysis tank having an ion permeable diaphragm between an anode and a cathode.

9. The method for surface treatment of a processed copper article according to any one of claims 1 to 7, wherein the electrolyzed acidic water is an electrolyzed acidic water having pH of at most 3 and an oxidation-reduction potential of 1,000 to 1,300 mV, obtainable by electrolyzing water having incorporated as an electrolyte, a compound capable of liberating sulfate ions when dissolved in water, using an electrolysis tank having an ion permeable diaphragm between an anode and a cathode.

10. The method for surface treatment of a processed copper article according to any one of claims 2 and 6 to 9, wherein the electrolyzed alkaline water to be used for the treatment with the electrolyzed alkaline water subsequent to the treatment with the electrolyzed acidic water is an electrolyzed alkaline water having pH of at least 10 and an oxidation-reduction potential of −150 to −900 mV, obtainable by electrolyzing water by using an electrolysis tank having an ion permeable diaphragm between an anode and a cathode.

11. The method for surface treatment of a processed copper article according to any one of claims 6 to 10, wherein the electrolyzed alkaline water to be used for the pre-treatment before the treatment with the electrolyzed acidic water is an electrolyzed alkaline water heated to at least 40 ° C., having pH of at least 10, an oxidation-reduction potential of −150 to −900 mV and a surface tension of at most 670 dyne/cm, which is obtainable by electrolyzing water by using an electrolysis tank having an ion permeable diaphragm between an anode and a cathode.

12. The method for surface treatment of a processed copper article according to any one of claims 1 to 11, wherein a waste water after the treatment with the electrolyzed acidic water is neutralized, and recovered or reused as a neutral water.

13. The method for surface treatment of a processed copper article according to claim 12, wherein a waste water after the treatment with the electrolyzed acidic water and a waste water after the treatment with the electrolyzed alkaline water are mixed and treated, and recovered or reused as a neutral water.

14. The method for surface treatment of a processed copper article according to any one of claims 1 to 13, wherein copper ions are separated and recovered from a waste water after the treatment with the electrolyzed acidic water or a neutral water obtainable by neutralizing said waste water.

15. The method for surface treatment of a processed copper article according to claim 14, wherein a waste water after the treatment with the electrolyzed acidic water or a neutral water obtainable by neutralizing said waste water is led into a copper ion recovery tank to separate and recover copper ions as copper hydroxide.

16. The method for surface treatment of a processed copper article according to any one of claims 1 to 15, wherein the processed copper article is one formed as a surface conductive electrode on a circuit board as an electronic part.
